(19) United States
(12) Patent Application Publication
(10) Pub. No.: US 2026/0050320 A1
(43) Pub. Date: Feb. 19, 2026

(54) PERIPHERAL DEVICE POWER GATING SYSTEMS AND METHODS

(71) Applicant: Lattice Semiconductor Corporation, Hillsboro, OR (US)

(72) Inventor: Satheesh Chellappan, El Dorado Hills, CA (US)

(21) Appl. No.: 19/291,511

(22) Filed: Aug. 5, 2025

Related U.S. Application Data
(60) Provisional application No. 63/682,751, filed on Aug. 13, 2024.

(51) Int. Cl. G06F 1/3296

(52) U.S. Cl. CPC G06F 1/3296

(57) ABSTRACT

Various techniques are provided for managing power modes (e.g., also referred to as power states) in peripheral devices connected to host devices. In one example, a method includes receiving, by an intermediate device communicatively connected between a host device and a peripheral device, a notification that the host device will transition from a high power mode to a reduced power mode. The method also includes receiving, by the intermediate device from the peripheral device, context data associated with an operational state of the peripheral device. The method also includes storing, by the intermediate device, the context data, and power gating the peripheral device by the intermediate device while the host device remains at least partially turned on in the reduced power mode. Additional embodiments are provided to restore the operational state of the peripheral device using the stored context data. Additional systems, devices, and methods are also provided.

### CROSS-REFERENCE TO RELATED APPLICATION

This application claims the benefit of and priority to U.S. Provisional Patent Application No. 63/682,751 filed Aug. 13, 2024 and entitled “PERIPHERAL DEVICE POWER GATING SYSTEMS AND METHODS,” which is incorporated herein by reference it its entirety.

### TECHNICAL FIELD

This disclosure relates generally to power savings for electronic devices and, more specifically, to techniques for managing power modes in such devices.

### BACKGROUND

Power savings is an important consideration in electronic devices. This is particularly relevant for mobile computing devices such as laptop computers, smartphones, and other devices. For example, certain techniques have been developed to permit devices to enter and exit various low power modes (e.g., also referred to as reduced power modes) under appropriate conditions.

In many cases, a peripheral device connected to a host device may achieve only limited power savings. For example, the peripheral device may be connected to the host device through an interface that limits the low power modes at which the peripheral device may be operated while the host device is at least partially turned on. For example, in some cases, if the host device transitions from a high power mode to a reduced power mode, the connected peripheral device may also be required to transition to the same reduced power mode.

However, even if the peripheral device is not actually in use while the host device is in the reduced power mode, the requirements of the interface may necessitate that the peripheral device remain at a minimum power mode (e.g., not fully turned off, also referred to as power gated) and therefore continue to draw substantial power from the host device. For example, the peripheral device may be required to remain sufficiently powered up in order to maintain the state of its local volatile memory (e.g., registers) and thereby retain context data to maintain its operational state for later use when the host device (and consequently the peripheral device also) transitions back to a higher power mode.

Unfortunately, these limitations can result in peripheral devices continuing to draw substantial power from the host device (e.g., drawing approximately 50 mW for some peripheral devices), even when the host device is in a low power mode and the peripheral devices are not in use. This can be particularly problematic for peripheral devices that remain constantly or permanently connected to the host device (e.g., a peripheral device provided as part of an accessory device integrated into the host device). As a result, conventional power management techniques may fail to fully achieve efficient power savings in many implementations.

### SUMMARY

Various techniques are provided for managing power modes (e.g., also referred to as power states) in peripheral devices connected to host devices. In one embodiment, a method includes receiving, by an intermediate device communicatively connected between a host device and a peripheral device, a notification that the host device will transition from a high power mode to a reduced power mode. The method also includes receiving, by the intermediate device from the peripheral device, context data associated with an operational state of the peripheral device. The method also includes storing, by the intermediate device, the context data. The method also includes power gating the peripheral device, by the intermediate device, while the host device remains at least partially turned on in the reduced power mode.

In another embodiment, a system includes an intermediate device communicatively connected between a host device and a peripheral device. The intermediate device is configured to receive a notification that the host device will transition from a high power mode to a reduced power mode. The intermediate device is configured to receive, from the peripheral device, context data associated with an operational state of the peripheral device. The intermediate device is configured store the context data. The intermediate device is configured power gate the peripheral device while the host device remains at least partially turned on in the reduced power mode. Additional embodiments are also disclosed.

### BRIEF DESCRIPTION OF THE DRAWINGS

FIG. 1 illustrates a block diagram of a programmable logic device (PLD) in accordance with an embodiment of the disclosure.

FIG. 2 illustrates a system including a host device connected to a peripheral device through an intermediate device in accordance with an embodiment of the disclosure.

FIG. 3 illustrates a circuit diagram of a transceiver of an intermediate device in accordance with an embodiment of the disclosure.

FIG. 4 illustrates a timing diagram associated with transitioning a peripheral device from a powered on mode to a power gated mode in response to a reduced power mode transition initiated by a host device in accordance with an embodiment of the disclosure.

FIG. 5 illustrates a process of transitioning a peripheral device from a powered on mode to a power gated mode in response to a reduced power mode transition initiated by a host device in accordance with an embodiment of the disclosure.

FIG. 6 illustrates a timing diagram associated with transitioning a peripheral device from a power gated mode to a powered on mode in response to a high power mode transition initiated by a host device in accordance with an embodiment of the disclosure.

FIG. 7 illustrates a process of transitioning a peripheral device from a power gated mode to a powered on mode in response to a high power mode transition initiated by a host device or the peripheral device itself in accordance with an embodiment of the disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

In accordance with various embodiments disclosed herein, techniques are provided for managing power modes (e.g., also referred to as power states) in peripheral devices connected to host devices. In some embodiments, a host device may be connected to a peripheral device through an intermediate device that controls power modes of the peripheral device. For example, the intermediate device may be an always-on intermediate device (e.g., or may include an always-on portion thereof, the portion also referred to as an always-on island of the peripheral device) connected to a downstream peripheral device through a communication interface (e.g., a USB interface or otherwise). The host device, the intermediate device, and/or the peripheral device may be selectively operated in a plurality of different power modes.

The intermediate device may manage operation of the peripheral device to cause the peripheral device to be selectively operated in a power gated mode that would not otherwise be permitted by the host device. For example, in some embodiments, the host device may enter a reduced power mode (e.g., where one or more components of the host device are operated at reduced power levels but are not completely turned off). In conventional systems, the connected peripheral device may be required to be operated at a minimum power mode such as at a reduced power mode corresponding to that of the host device, but not completely turned off (e.g., power gated), in order for the peripheral device to retain its current operational state.

In contrast, in accordance with various techniques of the present disclosure, the intermediate device may control the power mode of the peripheral device independently of the power mode of the host device to substantially improve power savings. For example, upon receiving a notification (e.g., detecting) that the host device is entering a reduced power mode, the intermediate device may store context data of the peripheral device and power off (e.g., power gate) the peripheral device while the intermediate device (or portion thereof) remains powered on.

In various embodiments, the intermediate device (or its always on portion) may be implemented as a thin low power device that draws less power while on than would be drawn by the peripheral device in the reduced power mode of the host device. As a result, even with the added intermediate device and its associated always-on power draw, the total power draw of the combination of the intermediate device and the peripheral device (while the host device in the reduced power mode) will be less than without intermediate device (e.g., with peripheral device remaining on at a minimum power level, such as a suspend state).

In some embodiments, the intermediate device and/or the peripheral device may be implemented by a programmable logic device (PLD). For example, in some embodiments, the intermediate device may be implemented by a PLD with reduced power draw such as an iCE 40 PLD, while the peripheral device may be implemented by a PLD with greater power draw such as an NX33 PLD, both available from Lattice Semiconductor Corporation of Hillsboro, Oregon.

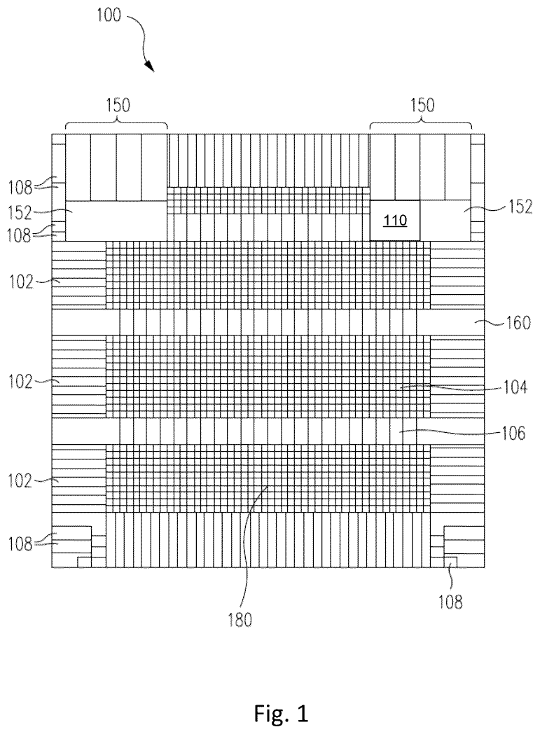

For example, FIG. 1 illustrates a block diagram of an example PLD 100 that may be used to implement the intermediate device and/or the peripheral device in accordance with an embodiment of the disclosure. For example, PLD 100 may be implemented with greater or fewer of the various components discussed herein to implement either device as appropriate.

PLD 100 (e.g., a field programmable gate array (FPGA)), a complex programmable logic device (CPLD), a field programmable system on a chip (FPSC), or other type of programmable device) generally includes various physical hardware components such as I/O (I/O) blocks 102, logic blocks 104 (e.g., also referred to as programmable logic blocks (PLBs), programmable functional units (PFUs), or programmable logic cells (PLCs)) and others as discussed.

I/O blocks 102 provide I/O functionality (e.g., to support one or more I/O and/or memory interface standards) for PLD 100, while logic blocks 104 provide logic functionality (e.g., look-up table (LUT) logic or logic gate array-based logic) for PLD 100. Additional I/O functionality may be provided by serializer/deserializer (SERDES) blocks 150 and physical coding sublayer (PCS) blocks 152. In various embodiments, I/O blocks 102 and SERDES blocks 150 may route signals to and from associated external ports (e.g., physical pins) of PLD 100. PLD 100 may also include hard intellectual property core (IP) blocks 160 to provide additional functionality (e.g., substantially predetermined functionality provided in hardware which may be configured with less programming than logic blocks 104).

PLD 100 may also include memory blocks 106 (e.g., blocks of EEPROM memory blocks, RAM (e.g., static and/or dynamic) memory blocks, and/or flash memory blocks), clock-related circuitry 108 (e.g., clock sources, PLL circuits, and/or DLL circuits), and/or various routing resources 180 (e.g., interconnect and appropriate switching logic to provide paths for routing signals throughout PLD 100, such as for clock signals, data signals, or others) as appropriate. In various embodiments, routing resources 180 may include user configurable routing resources and hardwired signal paths. In general, the various physical hardware components of PLD 100 may be used to perform their intended functions for desired applications, as would be understood by one skilled in the art.

For example, I/O blocks 102 may be used for programming PLD 100, such as memory blocks 106 (e.g., including volatile configuration memory) or transferring information (e.g., various types of data and/or control signals) to/from PLD 100 through various external ports as would be understood by one skilled in the art. I/O blocks 102 may provide a first programming port (which may represent a central processing unit (CPU) port, a peripheral data port, an SPI interface, and/or a sysCONFIG programming port) and/or a second programming port such as a joint test action group (JTAG) port (e.g., by employing standards such as Institute of Electrical and Electronics Engineers (IEEE) 1149.1 or 1532 standards). I/O blocks 102 typically, for example, may be included to receive configuration data and commands to configure PLD 100 for its intended use and to support serial or parallel device configuration and information transfer with SERDES blocks 150, PCS blocks 152, hard IP blocks 160, and/or logic blocks 104 as appropriate.

For example, in some embodiments any of the various components discussed herein may be configured in response to a configuration engine 110 (e.g., implemented by appropriate logic such as one or more processors, finite state machines, and/or other hardware and/or software) passing configuration data by routing resources 180. In some embodiments, configuration data may be stored locally on PLD 100, for example, in one or more memory blocks 106 and/or stored externally from PLD 100, for example in a memory 134 of an external system 130.

It should be understood that the number and placement of the various components are not limiting and may depend upon the desired application. For example, various components may not be required for a desired application or design specification (e.g., for the type of programmable device selected).

Furthermore, it should be understood that the components are illustrated in block form for clarity and that various components would typically be distributed throughout PLD 100, such as in and between logic blocks 104, hard IP blocks 160, and routing resources 180 to perform their conventional functions (e.g., storing configuration data that configures PLD 100 or providing interconnect structure within PLD 100). It should also be understood that the various embodiments disclosed herein are not limited to programmable logic devices, such as PLD 100, and may be applied to various other types of programmable devices, as would be understood by one skilled in the art.

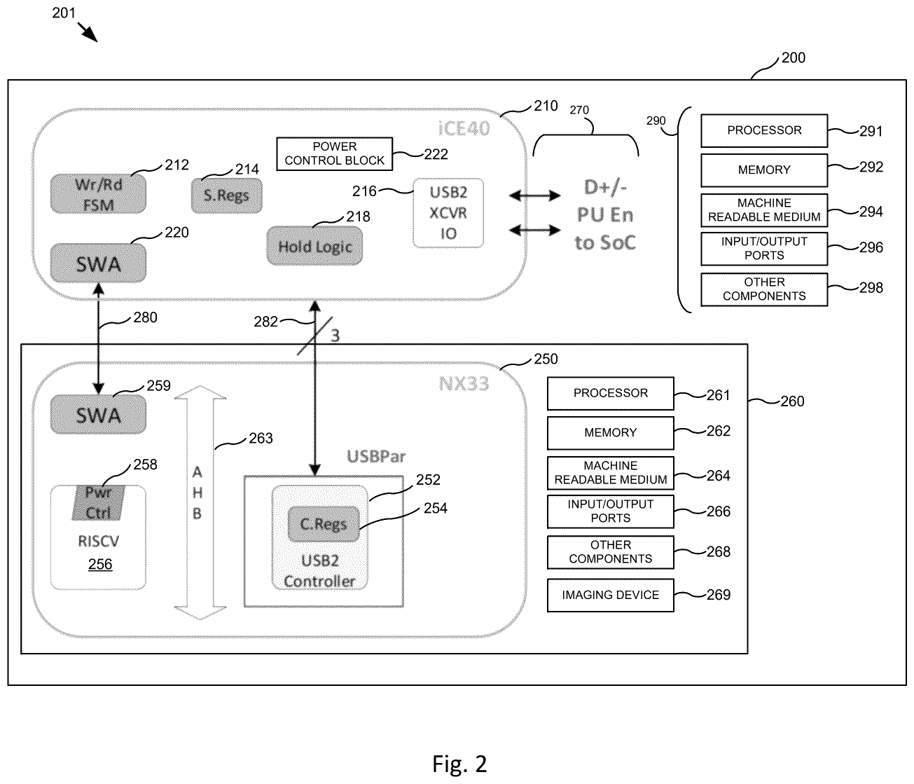

FIG. 2 illustrates a host device 200 connected to a peripheral device 250 through an intermediate device 210 to collectively provide a system 201 in accordance with an embodiment of the disclosure. In some embodiments, host device 200, intermediate device 210, and peripheral device 250 may each be capable of operating in a plurality of different power modes. Such power modes may include, for example: a high power mode where the device is operating at or near full power (e.g., a DO power state); a reduced power mode where the device is operating at a lower power level than the high power mode (e.g., a D1, D2, or D3 power state and/or a suspend mode); and a power off mode where the device is completely turned off (e.g., power gated). Although three power modes are identified for ease of discussion, additional power modes are also contemplated.

Although system 201 is illustrated in a generalized manner for ease of discussion, the illustrated features may be used to implement various types of systems. In some embodiments, intermediate device 210 and/or peripheral device 250 may be integrated into host device 200 to provide system 201 within host device 200 itself. For example, in some embodiments, host device 200 may be a computer system, such as a laptop computer system, mobile phone, and/or other appropriate type of device, intermediate device 210 may be integrated into host device 200, and peripheral device 250 may be part of an accessory device 260 that is also integrated into host device 200.

Continuing this example, peripheral device 250 may be part of (and/or provide supporting processing to) an accessory device 260 such as a camera (e.g., a computer vision chip used to detect the presence of a human, perform facial recognition, and/or otherwise by host device 200), a Wi-Fi™ chip, and/or other type of accessory device that is turned on and off with peripheral device 250. In the case of a camera, accessory device 260 may include various components, such as an imaging device 269 used to capture images of an environment of host device 200, one or more processors 261 that may be configured to execute instructions, such as software instructions to detect the presence of a human, perform facial recognition, and/or otherwise, provided in one or more memories 262 and/or stored in non-transitory form in one or more non-transitory machine-readable mediums 264 (e.g., a memory or other appropriate storage medium internal or external to system 201). Accessory device 260 may further include one or more input/output ports 266 and one or more other components 268 to implement additional features as appropriate. Other embodiments of accessory device 260 are also contemplated.

In some embodiments, host device 200, intermediate device 210, and peripheral device 250 may be connected by and communicate through a Universal Serial Bus (USB) interface. In this regard, although USB 2 will be primarily discussed and illustrated herein, the operations discussed herein may be applied to other types of USB interfaces (e.g., variants of USB 1.x, 2.x, 3.x, 4.x, and/or others), Thunderbolt™ interfaces (e.g., variants of Thunderbolt™ 1.x, 2.x, 3.x, 4.x, 5.x, and/or others) and/or other types of interfaces.

As shown, host device 200 includes various components 290 (e.g., implemented together as a system-on-chip (SoC), one or more discrete components, and/or otherwise) including, for example, one or more processors 291 that may be configured to execute instructions, such as software instructions, provided in one or more memories 292 and/or stored in non-transitory form in one or more non-transitory machine-readable mediums 294 (e.g., a memory or other appropriate storage medium internal or external to system 201). Host device 200 further includes one or more input/output ports 296 and one or more other components 298 to implement additional features as appropriate.

Intermediate device 210 is connected to host device 200 (e.g., connected to input/output ports 296) over a bus 270 (e.g., a USB bus in some embodiments). Peripheral device 250 is connected to intermediate device 210 over a bus 282 (e.g., operating as a proxy or digital interface with approximately 5 wires providing pass through functionality for USB communications in some embodiments). Accordingly, in some embodiments, peripheral device 250 does not communicate directly with components 290 of host device 200, but rather communicates through intermediate device 210 (e.g., intermediate device 210 passes USB communications between components 290 and peripheral device 250 over buses 270 and 282.

As shown, intermediate device 210 and peripheral device 250 are further connected by an additional bus 280. In some embodiments, bus 280 may be a single wire aggregate (SWA) bus providing serial communication over a single wire. In some embodiments, bus 280 may be used to pass context data between peripheral device 250 and intermediate device 210 and/or additional communications as discussed herein.

As discussed, intermediate device 210 and/or peripheral device 250 may be implemented by one or more appropriate PLDs configured (e.g., by appropriate logic blocks 140 and/or other components of the PLDs) to implement the various components and to perform the various operations discussed herein.

As shown, intermediate device 210 includes a finite state machine (FSM) 212, registers 214, a transceiver 216, hold logic 218, an SWA bus interface 220, and a power control block 222.

FSM 212 (e.g., implemented by configured logic blocks 140) operates to manage the storing of context data received from registers 254 of peripheral device 250 into registers 214 of intermediate device prior to a powering off (e.g., power gating) of peripheral device 250. Such context data may, for example, identify the current operational of peripheral device 250 (e.g., USB connect state, USB enumeration state, USB device address, previous USB enumeration configuration, FSM states, flags, and/or additional context data associated peripheral device 250) prior to being powered off, such that peripheral device 250 may be restored to the operational state after being powered off and powered back on by restoring the context data into registers 254.

FSM 212 further operates to manage the reading (e.g., readback) of the context data from registers 214 of intermediate device 210 and the passing of the context data back to peripheral device 250 after a powering on of peripheral device 250 (e.g., a restoring of peripheral device 250 from a powered off mode to a higher power mode).

Registers 214 (e.g., implemented by memory blocks 106) store context data received from registers 254 as discussed.

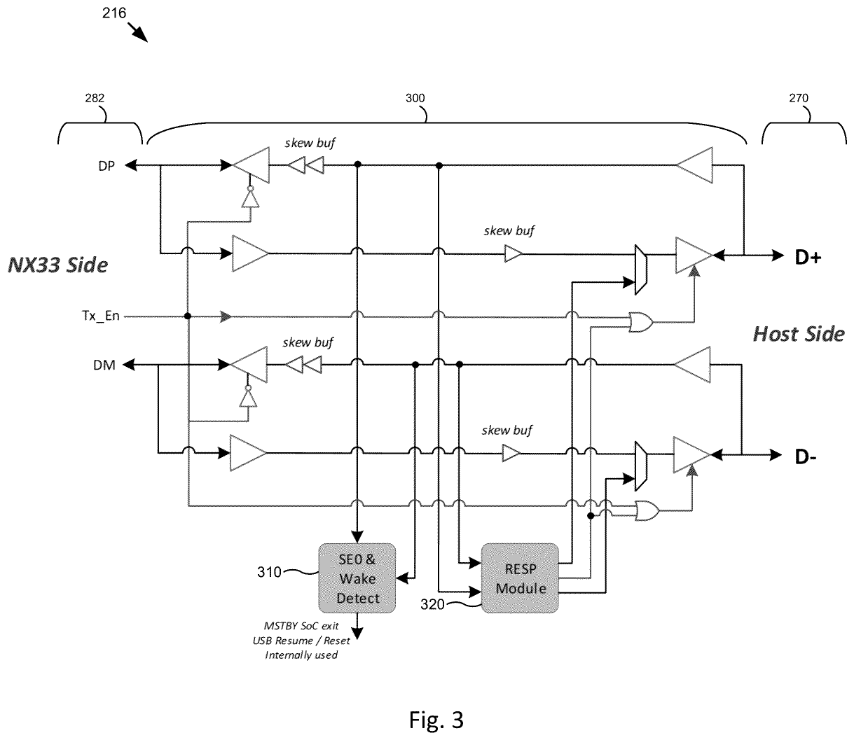

Transceiver 216 (e.g., implemented by configured logic blocks 140 and/or I/O blocks 102) provides a communication interface (e.g., a USB interface in some embodiments) to manage communication between intermediate device 210 and one or more components 290 over bus 270. Additional features of transceiver 216 are further discussed with regard to FIG. 3.

Hold logic 218 (e.g., implemented by configured logic blocks 140) operates to generate communications (e.g., USB NAK packets in some embodiments) for communication with components 290 of host device 200 to temporarily interrupt (e.g., cause a hold or wait) communications (e.g., USB communications) from host device 200 to peripheral device 250 (e.g., through intermediate device 210) while peripheral device 250 is being powered back up after being power gated as discussed herein.

SWA interface 220 (e.g., implemented by configured logic blocks 140 and/or I/O blocks 102) manages context data communications and/or other communications between intermediate device 210 and peripheral device 250 (e.g., serial communications over a single wire).

Power control block 222 (e.g., implemented by configured logic blocks 140) operates to selectively turn on and turn off peripheral device 250 (e.g., through appropriate control signals passed over SWA bus 280).

As shown, peripheral device 250 includes a controller 252, registers 254, a processing block 256 running firmware 258, an SWA bus interface 259, and a fabric 263.

Processing block 256 (e.g., implemented by configured logic blocks 140) operates to manage the reading of context data from registers 254 of peripheral device 250 and passing of the context data to intermediate device 210 prior to a powering off of peripheral device 250.

Processing block 256 further operates to manage the receiving (e.g., readback) of the context data from registers 214 of intermediate device 210 and the storing (e.g., restoring) of the context data into registers 254 of peripheral device after a powering on of peripheral device 250 (e.g., a restoring of peripheral device 250 from a power gated mode to a higher power mode).

Registers 254 (e.g., implemented by memory blocks 106) store context data as discussed.

Controller 252 (e.g., implemented by configured logic blocks 140) operates to manage communications (e.g., USB communications) between peripheral device 250 and intermediate device 210 over bus 282.

SWA interface 259 (e.g., implemented by configured logic blocks 140 and/or I/O blocks 102) manages context data communications and/or other communications between peripheral device 250 and intermediate device 210.

Fabric 263 (e.g., implemented by configured logic blocks 140 and/or routing resources 180) operates to provide interconnections between the various components of peripheral device 250.

FIG. 3 illustrates a circuit diagram of transceiver 216 of intermediate device 210 in accordance with an embodiment of the disclosure. As shown, transceiver 216 is connected to bus 270 (e.g., a USB bus in this embodiment) as previously discussed. Transceiver 216 includes circuitry 300 that operates to receive and convert analog communication signals received from components 290 of host device 200 over bus 270 into corresponding digital communication signals that are sent (e.g., passed) over bus 282 to peripheral device 250. Circuitry 300 also operates to receive and convert digital communication signals received from peripheral device 250 over bus 282 into corresponding analog communication signals that are sent (e.g., passed) over bus 270 to components 290 of host device 200. Thus, transceiver 216 may operate to route communications (e.g., USB communications) between host device 200 and peripheral device 250 through intermediate device 210.

Transceiver 216 further includes a detection module 310 that may detect notifications such as communications (e.g., USB wake data packets) received from host device 200 over bus 270 that identify that host device 200 will (e.g., is expected to) transition from a reduced power mode to a high power mode (e.g., waking up). For example, detection module 310 may provide such detected communications to FSM 212 and/or hold logic 218 to trigger intermediate device 210 (e.g., through power control block 222) to begin powering up (e.g., restoring) peripheral device 250 from a power off mode.

In response, hold logic 218 may generate communications (e.g., USB NAK packets in some embodiments) to temporarily interrupt communications (e.g., USB communications) from host device 200 to peripheral device 250 beginning, for example, at least when intermediate device 210 is preparing to power gate peripheral device 250 and continuing, for example, at least until when peripheral device 250 is restored to its operational state after the power gating. In this regard, transceiver 216 further includes a response module 320 configured to transmit the generated interrupting communications to host device 200 over bus 270.

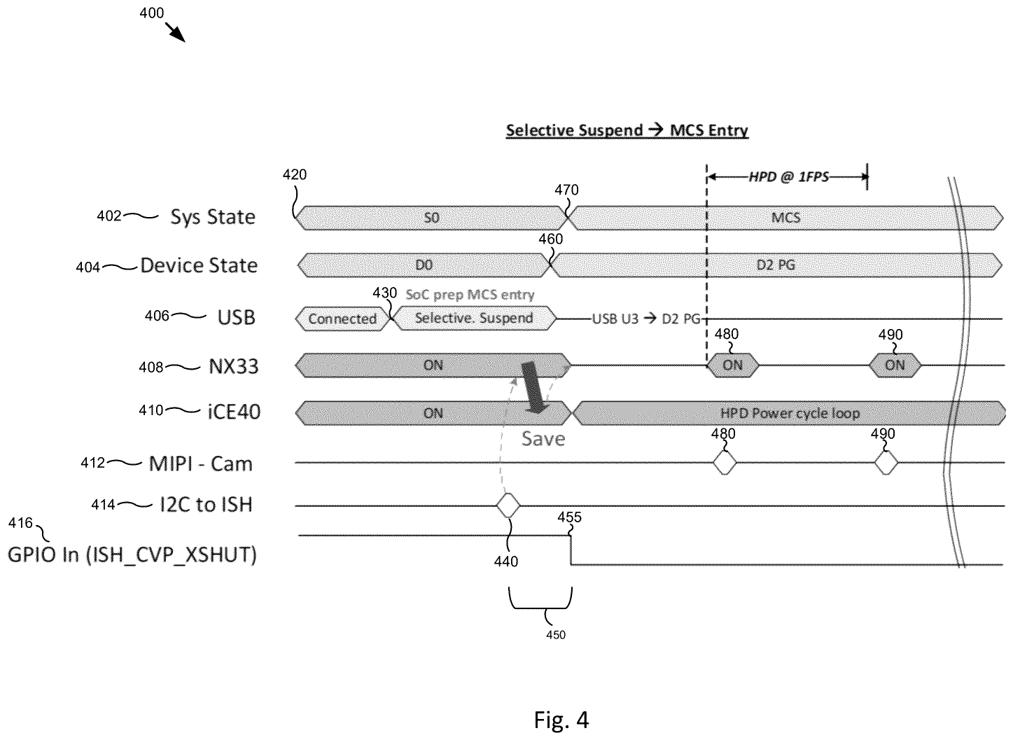

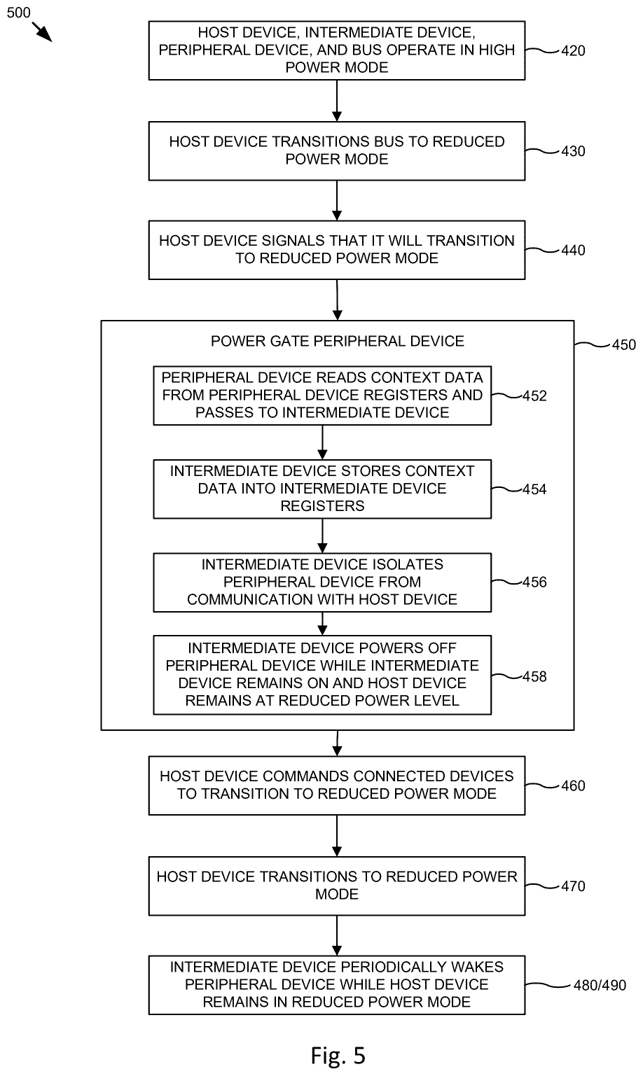

The operation of host device 200, intermediate device 210, and peripheral device 250 will be further discussed with regard to FIGS. 4-8. FIG. 4 illustrates a timing diagram 400 and FIG. 5 illustrates an associated process 500 identifying various operations associated with transitioning peripheral device 250 from a powered on mode to a power gated mode in response to a reduced power mode transition initiated by host device 200 in accordance with embodiments of the disclosure.

In FIG. 4, various plots 402-416 are illustrated that identify the operational state of various devices and related signals and conditions.

Plot 402 identifies the power mode of host device 200. As shown, host device 200 transitions between a high power mode (e.g., S0) and a reduced power mode (e.g., modern connected standby (MCS)).

Plot 404 identifies the power mode that host device 200 intends to operate devices connected to bus 270. As shown, host device 200 may instruct connected devices (e.g., intermediate device 210) to transition between a high power mode (e.g., D0) and a reduced power mode (e.g., D2).

Plot 406 identifies the status of bus 270. As shown, bus 270 may transition between a high power mode (e.g., connected state) where communications are maintained and a reduced power mode (e.g., selective suspend state) where communications are interrupted. For example, in an embodiment where bus 270 is implemented as a USB bus, host device 200 may cause bus 270 to transition to the selective suspend state if no communications are received by host device 200 over bus 270 within a time period (e.g., 3 milliseconds in some embodiments). As further shown, bus 270 may further transition to a reduced power mode (e.g., from a USB U3 suspend power mode to a USB D2 power mode).

Plot 408 identifies the power mode of peripheral device 250. As shown, peripheral device 250 transitions between a high power mode and a powered off (e.g., power gated) mode. As part of this transition, context data from registers 254 of peripheral device 250 is stored in registers 214 of intermediate device 210 as discussed.

As also shown, peripheral device 250 may be periodically powered back up from the powered off power mode to the high power mode for a temporary time period and then returned back to the powered off power mode. These temporary and periodic transitions may be performed (e.g., controlled by power control block 222 of intermediate device 210) to permit peripheral device 250 to be intermittently operated while host device 200 is in the reduced power mode. In some embodiments, context data is not restored to registers 254 as part of these temporary and periodic transitions.

For example, in some embodiments, peripheral device 250 may be part of an accessory device 260 that may be useful to operate periodically even while host device 200 is in a reduced power mode. For example, accessory device 260 may be a camera used to detect the presence of a human, perform facial recognition, and/or otherwise for purposes of waking host device 200 and transitioning host device 200 back from the reduced power mode to a high power mode in response to an operation of peripheral device 250 and/or accessory device 260 while temporarily powered on (e.g., in response to a user of host device 200 being detected by imaging device 269 of accessory device 260). In some embodiments, such periodic transitions may be performed at a rate of once per second (e.g., providing a frame rate of one captured image per second from imaging device 269).

Plot 410 identifies the power mode of intermediate device 210. As shown, intermediate device 210 transitions between a high power mode to a power gating control mode. In some embodiments, intermediate device 210 continues to operate at high power while in the power gating control mode. In some embodiments, portions of intermediate device 210 may operate in a reduced power mode during the power gating control mode, while other portions of intermediate device 210 may operate at high power (e.g., power control block 222) to control the power gating of peripheral device 250.

Plot 412 identifies the capturing of images by imaging device 269 of accessory device 260 during the temporary and periodic transitions at times 480 and 490 discussed with regard to plot 408.

Plot 414 identifies a notification (e.g., a USB data packet) generated by host device 200 and provided to intermediate device 210 over bus 270 to identify that host device 200 is preparing to perform the power transition shown in plot 402.

Plot 416 identifies a signal received by components 290 of host device 200. In some embodiments, the signal of plot 416 may trigger host device 200 to perform the power transition shown in plot 402. For example, in some embodiments where host device 200 is a laptop computer, the signal of plot 414 may transition at time 455 in response to host device 200 entering a sleep mode and/or other event that may trigger host device 200 to enter the reduced power mode. For example, in some embodiments, the transition shown at time 455 in plot 416 may occur prior to the transition shown at time 440 in plot 414 and may be the trigger that causes host device 200 to generate the signal shown in plot 414.

Timing diagram 400 will now be further described in relation to process 500 of FIG. 5. At time 420, host device 200, intermediate device 210, peripheral device 250, and bus 270 all operate in high power mode as shown in plots 402, 406, 408, and 410.

At time 430, host device 200 transitions bus 270 to a reduced power mode as discussed and shown in plot 406. At time 440, host device 200 notifies (e.g., signals) to intermediate device 210 that host device 200 is preparing to transition from the high power mode to a reduced power mode as shown in plot 414.

During time period 450, intermediate device 210 and peripheral device 250 perform a process to power gate peripheral device 250. As shown in FIG. 5, intermediate device 210 and peripheral device 250 perform various operations during time period 450. In some embodiments, time period 450 constitutes a relatively short time period (e.g., approximately 100 milliseconds in some embodiments) between time 440 (e.g., where host device 200 signals that a transition to a reduced power level is expected) and time 460 (e.g., where host device 200 commands connected devices to transition to the reduced power level). Accordingly, in some embodiments, intermediate device 210 and peripheral device 250 may rapidly perform their various operations during time period 450 to permit peripheral device 250 to be power gated before time 460.

For example, in block 452, peripheral device 250 reads context data from registers 254 (e.g., in response to a control signal provided from FSM 212 to processing block 256 over bus 280) and passes the context data to intermediate device 210 over bus 280. In block 454, intermediate device 210 stores the context data into registers 214.

In block 456, intermediate device 210 isolates peripheral device 250 from communication with host device 200 by disabling bus 282. For example, in some embodiments, hold logic 218 and transceiver 216 may operate to provide USB NAK packets from intermediate device 210 to host device 200 over bus 270 and thereby interrupt communications between host device 200 and peripheral device 250 over bus 282. As a result, peripheral device 250 may be safely power gated without missing communications from host device 200.

In block 458, intermediate device 210 powers off peripheral device 250 while intermediate device 210 (or at least a portion thereof as discussed) remains on and also while host device 200 remains at its reduced power mode. Thus, peripheral device 250 may be completely turned off for power savings even while host device 200 remains at least partially on in the reduced power mode.

At time 460, host device 200 commands connected devices (e.g., intermediate device 210) to transition to a reduced power mode as shown in plot 404. At time 470, host device 200 transitions to its reduced power mode as shown in plot 402.

At times 480 and 490, intermediate device 210 (e.g., by power control block 222) periodically turns peripheral device 250 on and off to perform various operations while host device 200 remains in the reduced power mode as discussed.

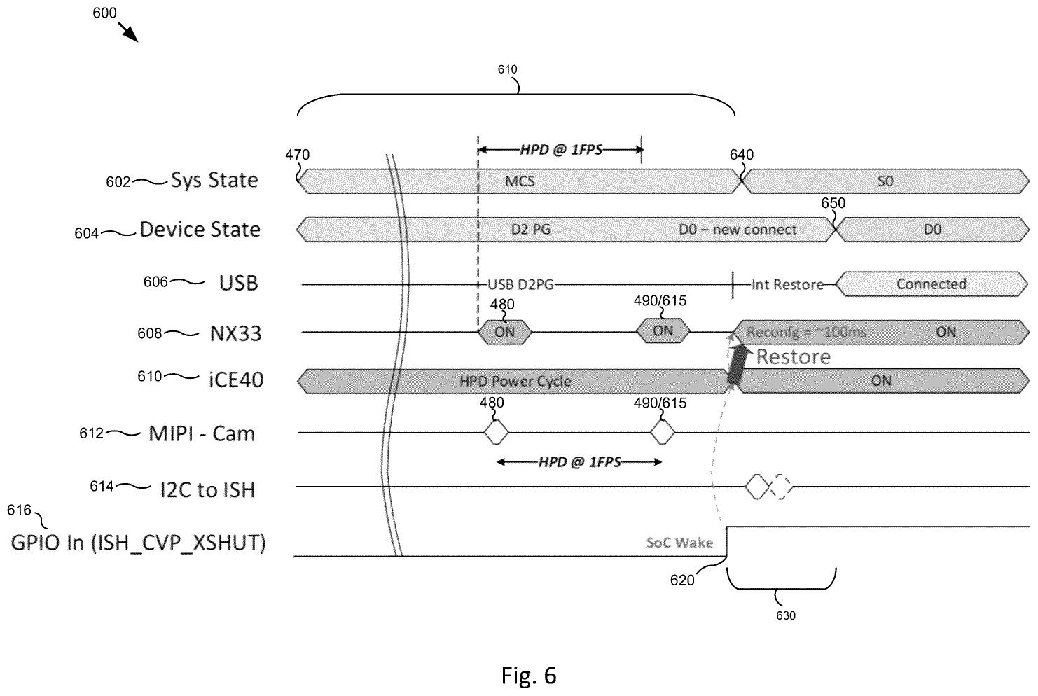

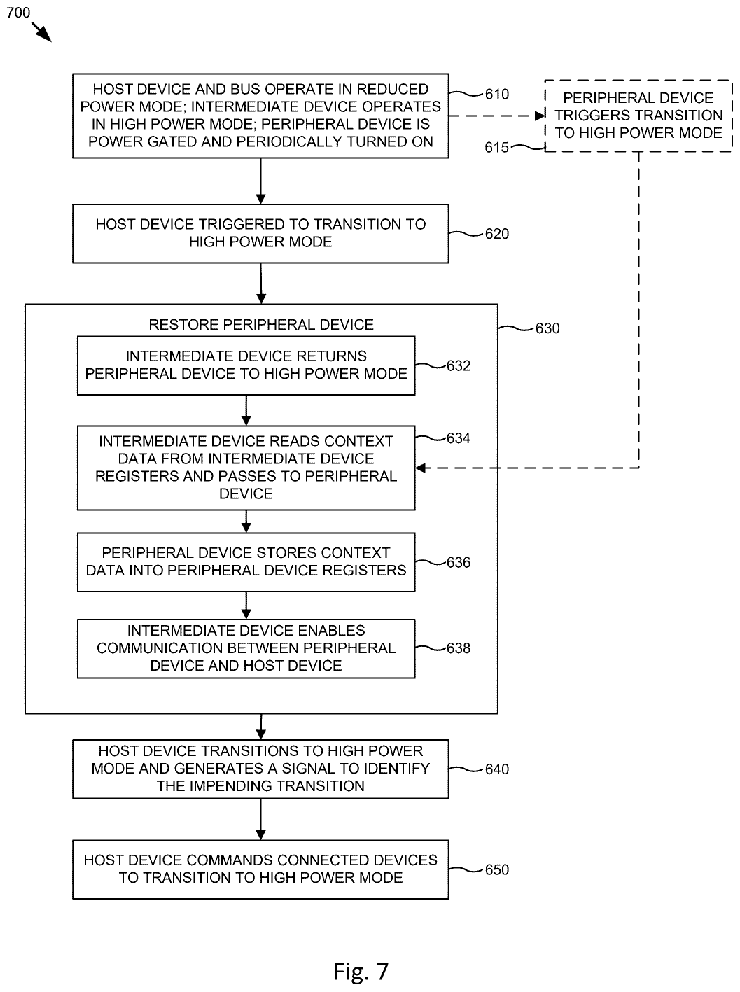

FIG. 6 illustrates a timing diagram 600 and FIG. 7 illustrates an associated process 700 identifying various operations associated with transitioning peripheral device 250 from a power gated mode to a powered on mode in response to a high power mode transition initiated by host device 200 or the peripheral device 250 itself in accordance with embodiments of the disclosure.

In FIG. 6, various plots 602-616 are illustrated that are continuations of corresponding plots 402-416 illustrated FIG. 4. Accordingly, time period 610 of timing diagram 600 corresponds to timing diagram 400 of FIG. 4 following time 470.

Timing diagram 600 will now be further described in relation to process 700 of FIG. 7. During time period 610, host device 200 and bus 270 both operate in a reduced power mode, intermediate device 210 (e.g., or a portion thereof) operates in a high power mode, and peripheral device 250 is power gated and periodically turned on (e.g., at times 480 and 490) as previously discussed in relation to FIGS. 4 and 5.

In some embodiments, peripheral device 250 may be transitioned to a high power mode and have its context data restored in response to various triggers. In one embodiment, the transition may be triggered while peripheral device 250 is fully turned off (e.g., outside of periodic times 480 and 490) at time 620. For example, in some embodiments where host device 200 is a laptop computer, the signal of plot 416 may transition at time 620 in response to host device 200 exiting a sleep mode and/or other event that may trigger host device 200 to transition to high power mode.

In another embodiment, the transition may be triggered while peripheral device 250 is temporarily turned on (e.g., during periodic time 480 or 490) at time 615 (e.g., as shown in the alternative broken line flow path illustrated in FIG. 7).

For example, as discussed, at times 480 and 490 (e.g., periodically any desired number of times), intermediate device 210 (e.g., by power control block 222) periodically turns peripheral device 250 on and off to perform various operations as discussed while host device 200 remains in the reduced power mode. In some embodiments, such operations may result in a trigger at time 615. For example, as discussed, peripheral device 250 may be part of an accessory device 260 such as a camera (e.g., used to detect the presence of a human, perform facial recognition, and/or otherwise by host device 200). In this example, if accessory device 260 detects a triggering event (e.g., a detection of the presence of a human, a successful facial recognition operation, and/or other event), peripheral device 250 may communicate with intermediate device 210 to trigger the restoration of context data to registers 254 for continued high power operation of peripheral device.

During time period 630, intermediate device 210 and peripheral device 250 perform a process to restore peripheral device 250. As shown in FIG. 7, intermediate device 210 and peripheral device 250 perform various operations during time period 630. In some embodiments, time period 630 constitutes a relatively small time period (e.g., approximately 100 milliseconds) between time 620 (e.g., where host device 200 is triggered) and time 650 (e.g., where host device 200 commands connected devices to transition to the high power level). Accordingly, in some embodiments, intermediate device 210 and peripheral device 250 may rapidly perform their various operations during time period 630 to permit peripheral device 250 to be restored before time 650.

In block 632, intermediate device 210 returns peripheral device 250 to high power mode, for example, through operation of power control block 222.

As discussed, the restoration of peripheral device 250 may alternatively be performed in response to a triggering event at time 615 resulting from the operation of accessory device 260 while peripheral device 250 is already turned on. In this case, as shown in the alternative broken line flow path, block 632 may be bypassed as peripheral device 250 is already turned on. In addition, in some embodiments, this alternative approach may provide additional time for intermediate device 210 and peripheral device 250 to perform their various operation during time period 630. For example, the triggering event resulting from accessory device 260 may occur while host device 200 itself has not yet been triggered to return to a high power mode. As a result, there is reduced risk that peripheral device 250 may not be ready when expected by host device 200.

In block 634, intermediate device 210 reads context data from registers 214 (e.g., in response to a control signal provided from processing block 256 to FSM 212 over bus 280) and passes the context data to peripheral device 250 over bus 280.

In block 636, peripheral device 250 stores the context data into registers 254. Thus, following block 636, peripheral device 210 has been restored to its previously powered on mode with its context data as it previously existed at time 420 of FIGS. 4 and 5.

Accordingly, in block 638, intermediate device 210 stops isolating peripheral device 250 from communication with host device 200 and reenables communication between peripheral device 250 and host device 200 through intermediate device 210. For example, in the case of USB communication, intermediate device 210 may stop sending USB NAK packets to host device 200 and may instead send appropriate data packets to indicate that intermediate device 210 (e.g., and therefore peripheral device 250) is available to communicate over bus 270.

In the case of the alternative flow path of FIG. 7, intermediate device 210 may also communicate a trigger (e.g., wake signal) to host device 200 over the now-enabled bus 270 to initiate a transition of host device 200 from reduced power mode to high power mode.

At time 640, host device 200 transitions to its high power mode in response to the trigger provided at time 620 or a trigger provided from intermediate device 210 as discussed. At time 650, host device 200 commands connected devices (e.g., intermediate device 210) to transition to high power mode as shown in plot 604. Following time 650, host device 200, intermediate device 210, and peripheral device 250 may operate in high power mode.

Where applicable, various embodiments provided by the present disclosure can be implemented using hardware, software, firmware, or combinations of hardware, software, and/or firmware. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method comprising:
receiving, by an intermediate device communicatively connected between a host device and a peripheral device, a notification that the host device will transition from a high power mode to a reduced power mode;
receiving, by the intermediate device from the peripheral device, context data associated with an operational state of the peripheral device;
storing, by the intermediate device, the context data; and
power gating the peripheral device, by the intermediate device, while the host device remains at least partially turned on in the reduced power mode.

2. The method of claim 1, further comprising:
receiving, by the intermediate device, a notification that the host device will transition from the reduced power mode back to the high power mode;
powering on the peripheral device, by the intermediate device, while the host device remains in the reduced power mode; and
passing, by the intermediate device to the peripheral device, the context data to permit the peripheral device to restore its operational state before the host device transitions back to the high power mode.

3. The method of claim 2, further comprising:
managing, by the intermediate device, communications between the host device and the peripheral device while the host device is in the high power mode;
disabling, by the intermediate device, the communications between the host device and the peripheral device through the intermediate device to communicatively isolate the peripheral device from the host device while the host device is in the reduced power mode; and
enabling, by the intermediate device, the communications between the host device and the peripheral device through the intermediate device after the peripheral device is restored to its operational state.

4. The method of claim 3, wherein the managing comprises:
converting analog communication signals received from the host device to digital communication signals sent to the peripheral device; and
converting digital communication signals received from the peripheral device to analog communication signals sent to the host device.

5. The method of claim 4, wherein:
the intermediate device sends and receives the analog communication signals over a first USB bus communicatively connecting the intermediate device with the host device; and
the intermediate device sends and receives the digital communication signals over a second USB bus communicatively connecting the intermediate device with the peripheral device.

6. The method of claim 2, wherein:
the notification of the transition from a high power mode to a reduced power mode is received from the host device; and
the notification of the transition from the reduced power mode back to the high power mode is received from the host device.

7. The method of claim 2, further comprising:
by the intermediate device, periodically powering the peripheral device on and off to permit the peripheral device to operate intermittently while the host device remains in the reduced power mode.

8. The method of claim 7, wherein:
the peripheral device is part of an accessory device integrated with the host device and configured to be periodically powered on and off with the peripheral device; and
the notification of the transition from the reduced power mode back to the high power mode is received from the peripheral device in response to an operation performed by the accessory device while periodically turned on.

9. The method of claim 8, wherein:
the host device is a computing device;
the accessory device is a camera; and
the operation is a detection of a human presence by the camera and/or a successful facial recognition by the camera.

10. The method of claim 1, wherein:
the intermediate device is a first programmable logic device (PLD);
the peripheral device is a second PLD; and
the intermediate device draws less power than the peripheral device.

11. A system comprising:
an intermediate device communicatively connected between a host device and a peripheral device, wherein the intermediate device is configured to:
receive a notification that the host device will transition from a high power mode to a reduced power mode;
receive, from the peripheral device, context data associated with an operational state of the peripheral device;
store the context data; and
power gate the peripheral device while the host device remains at least partially turned on in the reduced power mode.

12. The system of claim 11, wherein the intermediate device is configured to:
receive a notification that the host device will transition from the reduced power mode back to the high power mode;
power on the peripheral device while the host device remains in the reduced power mode; and
pass, to the peripheral device, the context data to permit the peripheral device to restore its operational state before the host device transitions back to the high power mode.

13. The system of claim 12, wherein the intermediate device is configured to:
manage communications between the host device and the peripheral device while the host device is in the high power mode;
interrupt the communications between the host device and the peripheral device through the intermediate device to communicatively isolate the peripheral device from the host device while the host device is in the reduced power mode; and
enable the communications between the host device and the peripheral device through the intermediate device after the peripheral device is restored to its operational state.

14. The system of claim 13, wherein the intermediate device comprises a transceiver configured to:
convert analog communication signals received from the host device to digital communication signals sent to the peripheral device; and
convert digital communication signals received from the peripheral device to analog communication signals sent to the host device.

15. The system of claim 14, wherein:
the intermediate device is configured to send and receive the analog communication signals over a first USB bus communicatively connecting the intermediate device with the host device; and
the intermediate device is configured to send and receive the digital communication signals over a second USB bus communicatively connecting the intermediate device with the peripheral device.

16. The system of claim 12, wherein:
the notification of the transition from a high power mode to a reduced power mode is received from the host device; and
the notification of the transition from the reduced power mode back to the high power mode is received from the host device.

17. The system of claim 12, wherein the intermediate device is configured to:
periodically power the peripheral device on and off to permit the peripheral device to operate intermittently while the host device remains in the reduced power mode.

18. The system of claim 17, wherein:
the peripheral device is part of an accessory device integrated with the host device and configured to be periodically powered on and off with the peripheral device; and
the notification of the transition from the reduced power mode back to the high power mode is received from the peripheral device in response to an operation performed by the accessory device while periodically turned on.

19. The system of claim 18, further comprising:
the host device, wherein the host device is a computing device;
the accessory device, wherein the accessory device is a camera; and
wherein the operation is a detection of a human presence by the camera and/or a successful facial recognition by the camera.

20. The system of claim 11, wherein:
the intermediate device is a first programmable logic device (PLD);
the peripheral device is a second PLD; and
the intermediate device draws less power than the peripheral device.
